(19) United States
(12) Patent Application Publication
(10) Pub. No.: US 2023/0169454 A1
(43) Pub. Date: Jun. 1, 2023

(54) ARTICLE SEARCH SUPPORT SYSTEM AND ARTICLE SEARCH SUPPORT METHOD

(71) Applicant: Hitachi, Ltd., Tokyo (JP)

(72) Inventors: Naoki FURUYA, Chiyoda-ku, Tokyo (JP); Manabu HASEGAWA, Chiyoda-ku, Tokyo (JP); Tadayoshi KOSAKA, Chiyoda-ku, Tokyo (JP)

(21) Appl. No.: 17/922,084

(22) PCT Filed: Feb. 25, 2021
(86) PCT No.: PCT/JP2021/007131

§ 371 Date: Oct. 28, 2022

(30) Foreign Application Priority Data
May 12, 2020 (JP) 2020-083590

(51) Int. Cl. G06Q 10/087

(52) U.S. Cl. CPC G06Q 10/087

(57) ABSTRACT

An article search support system 1 includes an arithmetic device configured to: create information on a history of processing of a plurality of articles 210 and a history of processing of an inclusion containing at least one of the plurality of articles 210 entailing the processing of the at least one article 210; create related information 14 chronologically storing processing targeting the article 210 and the inclusion or including the article 210 and the inclusion as targets by associating the processing of the article 210 with the processing of the inclusion containing the article 210 based on the created information on the history of each processing; receive an article 210 or inclusion input from a user; search the created related information 14 for information on processing associated with the input article 210 or inclusion and targeting the article 210 or the inclusion or including the article 210 or the inclusion as a target; and output the searched processing information.

### TECHNICAL FIELD

The present invention relates to an article search support system and an article search support method.

### BACKGROUND ART

This application claims priority based on Japanese Patent Application No. 2020-083590 filed on May 12, 2020, and the entire disclosure thereof is incorporated into this application.

Nowadays, due to factors such as a decrease in working population, needs for supply chain (hereinafter, referred to as SC) efficiency enhancement are high and a service is expanding so that the cause can be quickly specified in the event of a recall or the like while consistently managing the history of a product and goods (hereinafter, referred to as article) in the processing (e.g. manufacturing, logistics, distribution, sale) in each SC process. In many cases of this service, for example, an individual identification ID is assigned to each article, a tag such as a radio frequency identifier (RFID), a QR code (registered trademark), and a barcode is attached, and a worker performs article history management by reading the tag with a device such as a reader each time there is processing such as packing, receiving, and shipping in each process in the SC.

In a case where an article search service is built using such a tag, the amount of article history data increases as the number of handled articles increases, and thus it is required to be capable of expediting history data search. For example, JP-A-2009-123078 (PTL 1) discloses expediting history data search processing by pre-grouping a plurality of pieces of history data on the same article.

### CITATION LIST

### Patent Literature

PTL 1: JP-A-2009-123078

### SUMMARY OF INVENTION

### Technical Problem

However, in the process of logistics and distribution (e.g. logistics warehouse), work may occur such as packing a plurality of collected articles in one packing box (e.g. case or folding container hereinafter referred to as collapsible container) in response to an order from a sale store (mixed loading) and article repacking. In the method of PTL 1, in such a case where a plurality of articles are mixed or mixed-loaded in the same packing box or article repacking or the like is performed, the history data in the preceding process and the history data in the following process are handled as separate groups, and thus the processing of searching for the entire history data on a search target article becomes time-consuming.

Further, for example, in a case where a certain manufacturer searches for the manufacturer's goods at a logistics warehouse using a search service in the event of a recall related to the manufacturer's goods and goods from a plurality of manufacturers are mixed-loaded in, for example, the same packing box at the logistics warehouse and shipped to a store or the like, information on goods from another maker (e.g. purchase quantity or price) may be disclosed as a result of the search and then a store's sale strategy or the like may be leaked to another maker. In other words, it is necessary for a search system not to disclose, to a searching manufacturer, information on another maker's article packed in the same packing box.

However, the method of PTL 1 is irrelevant to a mechanism in which history data on a maker's goods is kept confidential from another maker requesting goods information disclosure in a case where there is history data indicating a state where goods from the plurality of makers are mixed-loaded.

The present invention has been made in view of such circumstances, and an object of the present invention is to provide a search method and a search system allowing article processing information search to be performed with ease and in an appropriate range.

### Solution to Problem

One of the present invention for achieving the above object is an article search support system including an arithmetic device configured to execute: history information creation processing for creating information on a history of processing of a plurality of articles and a history of processing of an inclusion containing at least one of the plurality of articles entailing the processing of the at least one article; related information creation processing for creating related information as information chronologically storing processing targeting the article and the inclusion or including the article and the inclusion as targets by associating the processing of the article with the processing of the inclusion containing the article based on the created information on the history of each processing; search request acquisition processing for receiving an article or inclusion input from a user; related information search processing for searching the created related information for information on processing associated with the input article or inclusion and targeting the article or the inclusion or including the article or the inclusion as a target; and search result display processing for outputting the searched processing information.

In addition, another one of the present invention for achieving the above object is an article search support method in which an information processing device executes: history information creation processing for creating information on a history of processing of a plurality of articles and a history of processing of an inclusion containing at least one of the plurality of articles entailing the processing of the at least one article; related information creation processing for creating related information as information chronologically storing processing targeting the article and the inclusion or including the article and the inclusion as targets by associating the processing of the article with the processing of the inclusion containing the article based on the created information on the history of each processing; search request acquisition processing for receiving an article or inclusion input from a user; related information search processing for searching the created related information for information on processing associated with the input article or inclusion and targeting the article or the inclusion or including the article or the inclusion as a target; and search result display processing for outputting the searched processing information.

### Advantageous Effects of Invention

According to the present invention, article processing information search can be performed with ease and in an appropriate range.

Objects, configurations, and effects other than the above will be clarified by the following description of an embodiment.

### BRIEF DESCRIPTION OF DRAWINGS

FIG. 1 is a diagram illustrating an example of a configuration of an article search support system according to the present embodiment.

FIG. 2 is a diagram illustrating an example of a supply chain according to the present embodiment.

FIG. 3 is a diagram illustrating an example of hardware of a search support device and a client terminal.

FIG. 4 is a diagram illustrating an example of functions of the article search support system.

FIG. 5 is a diagram illustrating an example of history information according to the present embodiment.

FIG. 6 is a diagram illustrating an example of the history information according to the present embodiment.

FIG. 7 is a diagram illustrating an example of the history information according to the present embodiment.

FIG. 8 is a diagram illustrating an example of the history information according to the present embodiment.

FIG. 9 is a diagram illustrating an example of the history information according to the present embodiment.

FIG. 10 is a diagram illustrating an example of a data structure of an ownership information DB.

FIG. 11 is a diagram illustrating an example of index information.

FIG. 12 is a diagram illustrating an example of history management information.

FIG. 13 is a diagram illustrating an example of related information.

FIG. 14 is a flowchart illustrating a typical procedure of package search-related processing (search processing) performed in the article search support system.

FIG. 15 is a flowchart illustrating an example of history information creation processing.

FIG. 16 is a flowchart illustrating ownership update processing in detail.

FIG. 17 is a flowchart illustrating related information creation processing in detail.

FIG. 18 is a flowchart illustrating an example of history information search processing.

FIG. 19 is a flowchart illustrating an example of result display processing.

FIG. 20 is an example of a process display screen.

FIG. 21 is a diagram illustrating another example of the process display screen.

### DESCRIPTION OF EMBODIMENTS

Details of an embodiment of the present invention will be described below. It should be noted that in the description of this specification, in a case where there are a plurality of functionally identical or similar elements, the elements may be described with the same reference numerals and different suffixes. However, suffixes may be omitted in the description in a case where there is no need to distinguish between a plurality of elements.

### <System Configuration>

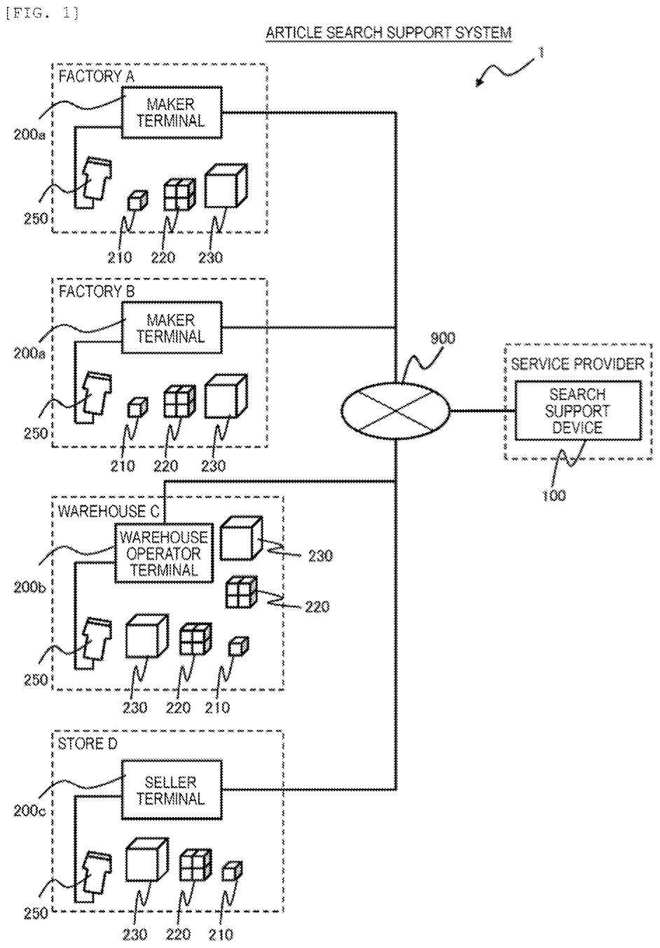

FIG. 1 is a diagram illustrating an example of a configuration of an article search support system 1 according to the present embodiment. The article search support system 1 is, for example, an information processing system introduced into a supply chain configured by bases (“factory A”, “factory B”, “warehouse C”, “store D”) where processing is performed in processes such as article manufacturing, distribution, and sale.

The article search support system 1 is configured to include a search support device 100 managed by a service provider providing an article search service using the supply chain as a target and a client terminal 200 installed at each base.

In other words, the client terminal 200 includes maker terminals 200a respectively managed by manufacturers manufacturing articles 210 at the bases “factory A” and “factory B”, a distributor terminal 200b managed by a logistics provider packing one or more articles 210 at the base “warehouse C”, and a seller terminal 200c managed by a seller unpacking the packed articles 210 and selling each article 210 at the base “store D”.

Performed at each of “factory A” and “factory B” is each process of manufacturing the article 210, packing the manufactured article 210 into a first packing box 220, or packing the first packing box 220 into a second packing box 230. Also performed at “factory A” and “factory B” is, for example, each process of shipping the article 210, the first packing box 220, and the second packing box 230. It should be noted that the article 210 processed at “factory A” and the article 210 processed at “factory B” are different in type.

The article 210, the first packing box 220, and the second packing box 230 are received at “warehouse C” from, for example, “factory A” and “factory B”. Also performed at “warehouse C” is, for example, each process of unpacking the first packing box 220 from the second packing box 230, unpacking the article 210 from the first packing box 220, packing the article 210 into a new first packing box 220, and packing the new first packing box 220 into a new second packing box 230. Also performed at “warehouse C” is, for example, each process of shipping the new first packing box 220 and the new second packing box 230. It should be noted that the article 210, the first packing box 220, and the second packing box 230 may be received from a plurality of manufacturers.

The new first packing box 220 and the new second packing box 230 are received at “store D” from, for example, “warehouse C”. Also performed at “store D” is, for example, each process of unpacking the new first packing box 220 from the new second packing box 230, unpacking the article 210 from the new first packing box 220, and unpacking the article 210. Also performed at “store D” is, for example, each process of unpacking the article 210 and the new first packing box 220 and selling the new second packing box 230.

It should be noted that in the present embodiment, the article 210, the first packing box 220, and the second packing box 230 are collectively referred to as “package”. It should be noted that the first packing box 220 and the second packing box 230 are, for example, article-storable containers such as bowls, cases, and collapsible containers or objects such as pallets and cage carts where a plurality of the articles 210 or containers can be placed.

In this manner, in the article search support system 1 of the present embodiment, article distribution is performed using the first packing box 220 containing the article 210 and the second packing box 230 containing the first packing box 220. Further, in this case, the processing targeting the first packing box 220 (packing and unpacking) includes processing with respect to the article 210 contained in the first packing box 220, and the processing targeting the second packing box 230 (packing and unpacking) includes processing with respect to the first packing box 220 and the article 210 contained in the second packing box 230.

It should be noted that the search support device 100 and each client terminal 200 in the article search support system 1 are connected so as to be capable of communication by a wired or wireless network 900 such as a local area network (LAN), a wide area network (WAN), the Internet, and a dedicated line.

A reading device 250 is connected to the maker terminal 200a of each manufacturer. The reading device 250 reads information (hereinafter, referred to as process information) recorded on a tag (e.g. RFID, QR code (registered trademark)) attached to each of the article 210, the first packing box 220, and the second packing box 230 that the manufacturer manufactures or manages at the base of the manufacturer and transmits the read information to the maker terminal 200a. It should be noted that information on the base of the manufacturer (“factory A”, “factory B”) indicating the manufacturer's ownership is recorded on the tag.

The reading device 250 is connected to the distributor terminal 200b managed by a distributor. The reading device 250 reads information (process information) recorded on a tag (e.g. RFID, QR code (registered trademark)) attached to each of the article 210, the first packing box 220, and the second packing box 230 that the distributor manages at the base of the distributor and transmits the read information to the distributor terminal 200b. It should be noted that information on the base of the distributor (“warehouse C”) indicating the distributor's ownership is recorded on the tag.

The reading device 250 is connected to the seller terminal 200c managed by the seller. The reading device 250 reads information (process information) recorded on a tag (e.g. RFID, QR code (registered trademark)) attached to each of the article 210, the first packing box 220, and the second packing box 230 that the seller manages at the base of the seller and transmits the read information to the seller terminal 200c. It should be noted that information on the base of the seller (“store D”) indicating the seller's ownership is recorded on the tag.

The search support device 100 receives an article-related search request from each client terminal 200. With the search request received, the search support device 100 returns history data on each article corresponding to the received search request to the client terminal 200 that sends the search request while performing, for example, predetermined anonymization processing based on ownership.

Here, details of the processing of each process in the supply chain that is a premise of the present embodiment will be described.

### (Details of Supply Chain)

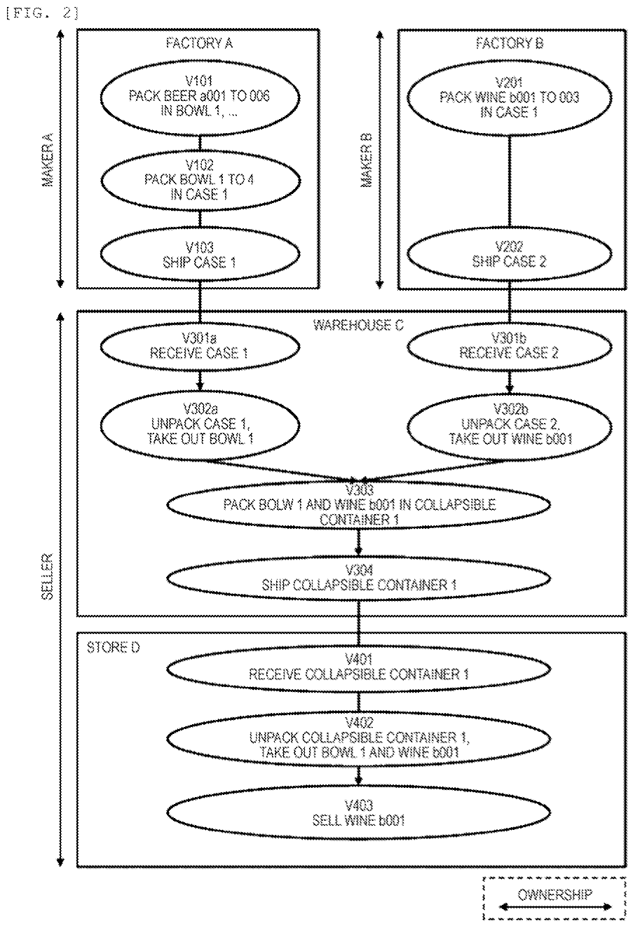

FIG. 2 is a diagram illustrating an example of the supply chain according to the present embodiment.

In the present embodiment, there are “factory A” and “factory B” managed by the manufacturers, beer is manufactured as the article 210 at “factory A”, and wine is manufactured as the article 210 at “factory B”. In addition, the distributor at “warehouse C” processes the wine sent from “factory A” and the wine sent from “factory B” (beer- or wind-related packing or unpacking). In addition, the seller at “store D” sells the beer and wine sent from “warehouse C”.

First, at “factory A”, the manufacturer packs 24 bottles of beer with the product name of “beer a” (package ID: beer a001 to beer a024) into a total of four bowls (“bowls 1 to 4”), six bottles in each bowl (first packing box 220) (process V101). Next, the manufacturer packs the four bowls (“bowls 1 to 4”) into “case 1” (second packing box 230) (process V102). Next, the manufacturer ships “case 1” to “warehouse C” (process V103).

Meanwhile, at “factory B”, the manufacturer packs three bottles of wine with the product name of “wine b” (package ID: wine b001 to wine b003) in “case 2” (second packing box 230) (process V201). Next, the manufacturer ships the “case 2” to the warehouse C (process V202).

Next, at “warehouse C”, the warehouse operator receives the case 1 from the factory A and the case 2 from the factory B (process V301a, process V301b). The warehouse operator unpacks the case 1 and takes out the bowl 1 (second packing box 230) (process V302a). In addition, the warehouse operator unpacks the case 2 and takes out the wine b001 (article 210) (process V302b). Next, the warehouse operator packs the bowl 1 taken out and the wine b001 taken out into a collapsible container 1 (second packing box 230) (mixed loading) (process V303). The warehouse operator C ships the collapsible container 1 to a retailer D (process V304).

At “store D”, the retailer receives the collapsible container 1 from “warehouse C” (process V401). The retailer unpacks the collapsible container 1 and displays the bowl 1 (first packing box 220) and the wine b001 (article 210) at the store (process V402). The retailer sells the displayed wine b001 to a customer (process V403).

Here, in the present embodiment, the pre-maker shipping beer a at the factory A is owned by the manufacturer managing the factory A. In addition, the pre-maker shipping beer b at the factory of the factory B is owned by the manufacturer managing the factory B.

Further, in the present embodiment, the processing of shipping the cases 1 and 2, which are packages, to the warehouse C entails processing the beer a and the wine b contained therein. Accordingly, the ownership of the beer a and the ownership of the wine b are transferred from the warehouse operator to the seller when the beer a and the wine b are received at the warehouse C.

Next, in the present embodiment, the warehouse C and the store D are owned by the seller (e.g. convenience store manager). Accordingly, the processing of shipping the collapsible container 1, which is a package, to the store D entails processing the beer a and the wine b contained therein. As a result, the seller retains the ownership of the beer a and the ownership of the wine b even when the beer a and the wine b are received at the store D.

Next, functions of the article search support system 1 will be described.

### <Functions>

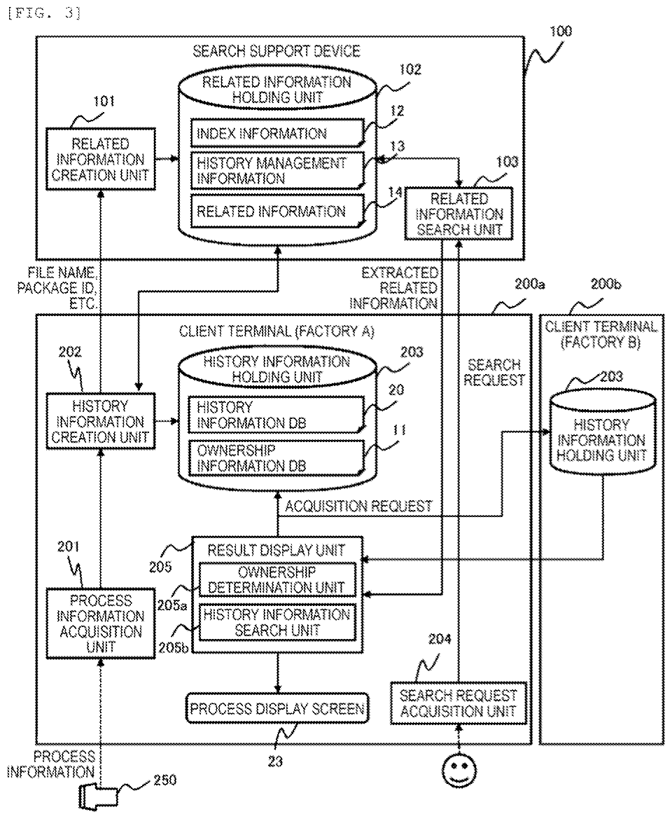

FIG. 3 is a diagram illustrating an example of the functions of the article search support system 1.

### —Client Terminal—

First, the client terminal 200 includes functional units of a process information acquisition unit 201, a history information creation unit 202, a history information holding unit 203, a search request acquisition unit 204, and a result display unit 205.

The process information acquisition unit 201 acquires process information from the reading device 250.

The history information creation unit 202 creates history information, which is information on the history of processing of each package indicated by the process information, based on the process information acquired by the process information acquisition unit 201 and transmits the created history information to the history information holding unit 203.

In other words, the history information creation unit 202 creates information on the history of processing of the plurality of articles 210 and the history of processing of an inclusion containing at least one of the plurality of articles 210 (first packing box 220 and second packing box 230) that entails the processing of at least one article (i.e. history information of each package).

In addition, the history information creation unit 202 stores information on a right holder (owner in the present embodiment) that has the authority to process each package.

In addition, the history information creation unit 202 transmits an identifier (file name in the present embodiment) of the created information on the history of each processing (history information 10) to the search support device 100.

Here, a specific example of the history information 10 will be described.

### (History Information)

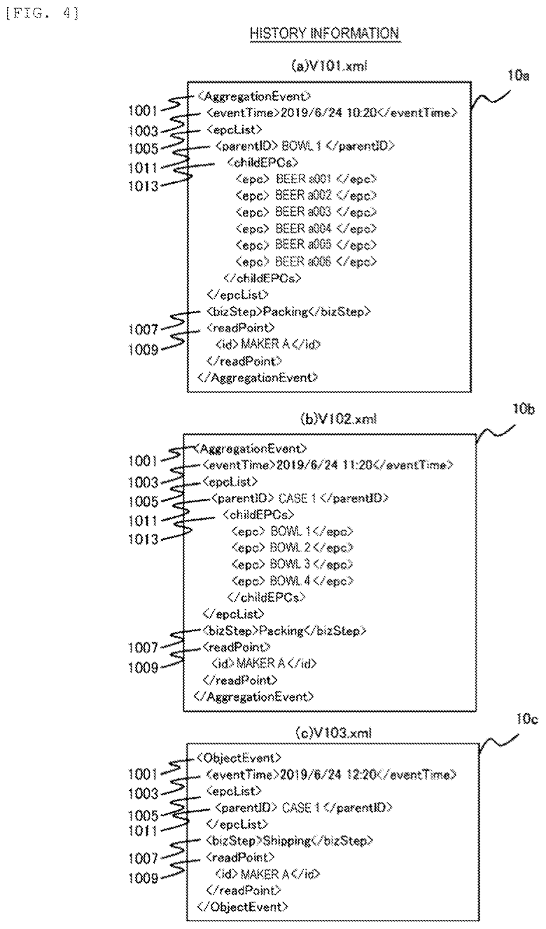

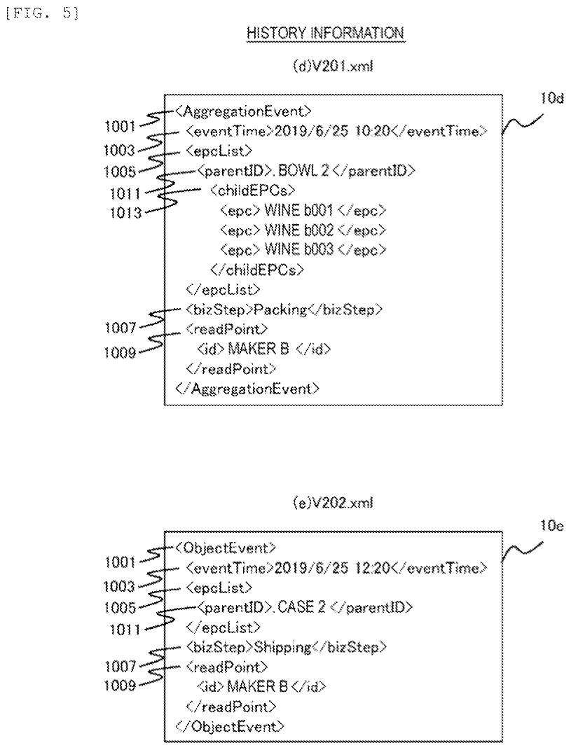

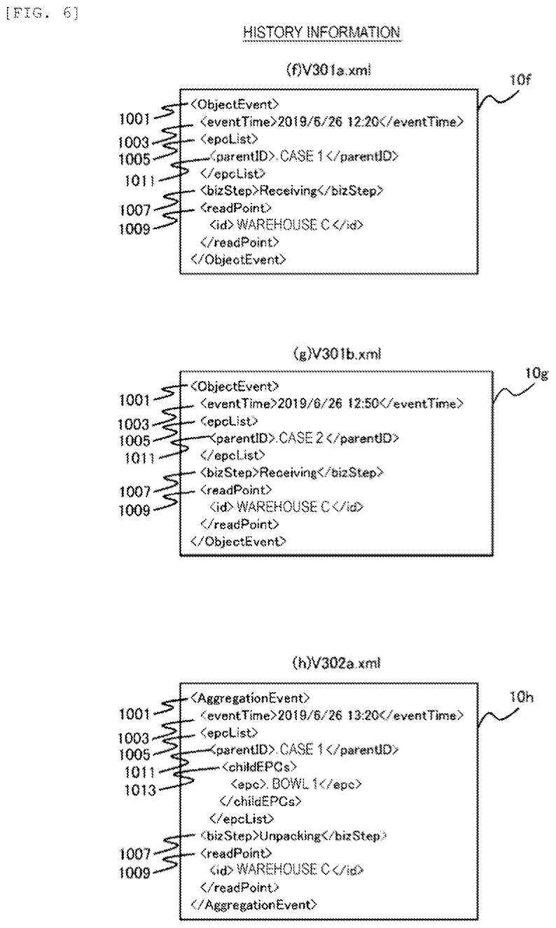

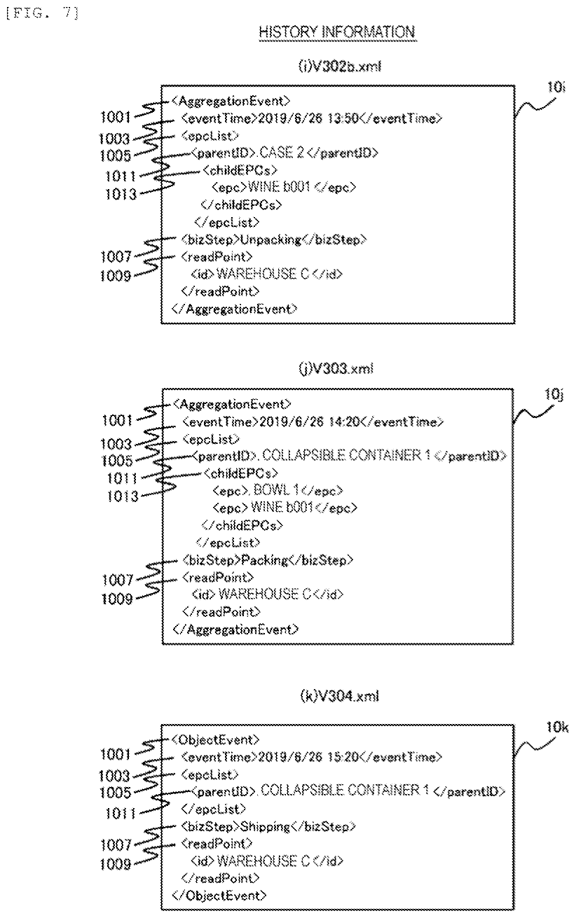

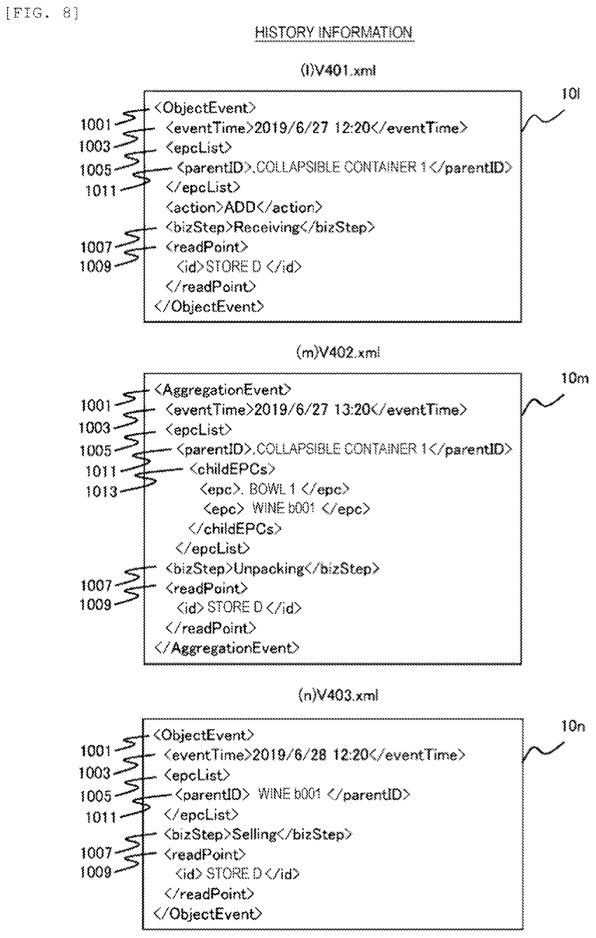

FIGS. 4 to 8 are diagrams illustrating an example of the history information 10 (10a to 10n) according to the present embodiment (divided into a plurality of drawings for space limitations).

History information 10a corresponds to the process V101, history information 10b corresponds to the process V102, history information 10c corresponds to the process V103, history information 10d corresponds to the process V201, history information 10e corresponds to the process V202, history information 10f corresponds to the process V301a, history information 10g corresponds to the process V301b, history information 10h corresponds to the process V302a, history information 10i corresponds to the process V302b, history information 10j corresponds to the process V303, history information 10k corresponds to the process V304, history information 10l corresponds to the process V401, history information 10m corresponds to the process V402, and history information 10n corresponds to the process V403. It should be noted that although the history information 10 (10a to 10n) indicates only an example of the history information 10 in the case of packing six bottles of beer a001 to a006, which are the articles 210, into the bowl 1, the same applies to the case of packing the rest of the articles 210, that is, packing the beer a007 to beer a0024 into the bowls 2 to 4, six bottles in each bowl.

The history information 10 has a process category-indicating event portion 1001. Set in the event portion 1001 is packing- or unpacking-indicating “AggregationEvent” or receiving and shipping- or sale-indicating “ObjectEvent”.

In addition, the event portion 1001 has, as a constituent element thereof, at least one of an event occurrence date and time 1003 (eventTime) where the date and time when a process is performed is set, a package specifying portion 1005 (epcList) where a list of IDs of packages (packing box or article) as work targets in the process is set, an event type portion 1007 (bizStep) where process type information (Packing indicating packing, Shipping indicating shipping, or Unpacking indicating unpacking) is set, and a place specifying portion 1009 (readPoint) where information on the base where the process is performed is set.)

In addition, the package specifying portion 1005 (epcList) further includes, as a constituent element thereof, at least one of a parent ID 1011 (parentID) as the ID of the inclusion with respect to the article 210 (first packing box 220 or second packing box 230, hereinafter, referred to as parent article) and a child ID 1013 (childEPCs) as the ID of the component article with respect to the inclusion related to the parent ID 1011 (article 210 or first packing box 220, hereinafter, referred to as child article).

Information on a plurality of packages may be set in each of the parent ID 1011 (parentID) and the child ID 1013. For example, in a case where “AggregationEvent” is set in the event portion 1001, the IDs of the plurality of first packing boxes 220 or second packing boxes 230 may be set in the parent ID 1011 and the IDs of the plurality of first packing boxes 220 or articles 210 may be set in the child ID 1013.

It should be noted that although a data structure of the history information 10 is the Electronic Product Code Information Services (EPCIS) in the present embodiment, the information may be based on any other structure. In addition, although the format of the history information 10 is Extensible Markup Language (XML) in the present embodiment, the format may be any other format such as JavaScript Object Notation (JSON).

Next, as illustrated in FIG. 3, the history information holding unit 203 stores the history information 10 created by the history information creation unit 202 in a history information DB 20. In addition, the history information holding unit 203 extracts ownership information related to the article 210, the first packing box 220, and the second packing box 230 based on the history information 10 created by the history information creation unit 202 and stores the extracted information in an ownership information DB 11.

### (Ownership Information DB)

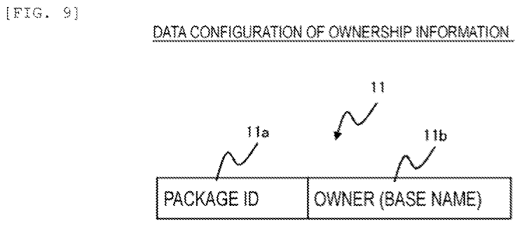

FIG. 9 is a diagram illustrating an example of a data structure of the ownership information DB 11. The ownership information DB 11 is configured by at least one record having the items including a package ID 11a where the package ID of each package is set and an owner lib, which is information indicating the right holder of the package related to the package ID 11a (owner and base information in the present embodiment).

Next, as illustrated in FIG. 3, the search request acquisition unit 204 receives an input (search request) of the article 210 or inclusion from a user.

The result display unit 205 includes an ownership determination unit 205a and a history information search unit 205b. The result display unit 205 displays information on a search result created based on a search request.

In other words, the result display unit 205 outputs information (package information) on the processing of the article 210 or inclusion (first packing box 220 and second packing box 230) searched for by a related information search unit 103 of the search support device 100, which will be described later. Specifically, the result display unit 205 outputs information on the processing to a process information display screen 23, which will be described later.

Based on information on the subject (business operator or base) incidental to the information on the article 210 or inclusion input by the search request acquisition unit 204 and the right holder information stored by the history information creation unit 202, the ownership determination unit 205a determines whether or not the subject has ever had authority over the article 210 or inclusion searched for by the search support device 100, which will be described later. Depending on whether or not the subject has ever had authority over the searched article 210 or inclusion, the ownership determination unit 205a varies how to display information on the processing targeting the searched article or inclusion (e.g. solid- or dotted-line display).

### —Search Support Device—

Next, the search support device 100 includes functional units of a related information creation unit 101, a related information holding unit 102, and the related information search unit 103.

First, based on the information on the history of each processing created by the history information creation unit 202 of the client terminal 200 (history information 10), the related information creation unit 101 associates the processing of the article 210 with the processing of the inclusion containing the article 210 (first packing box 220 and second packing box 230) to create related information 14, in which processing targeting the article 210 and inclusion or including the article 210 and inclusion as targets is stored chronologically.

Specifically, based on each identifier (e.g. file name) received from the client terminal 200, the related information creation unit 101 creates the related information 14 by associating the processing of the article 210 with the processing of the inclusion containing the article 210.

In addition, the related information creation unit 101 updates the related information 14 by associating the processing of the article 210 and inclusion created by the history information creation unit 202 with the latest processing of the article 210 or inclusion in the related information 14 that is already created.

Next, the related information search unit 103 searches the related information 14 created by the related information creation unit 101 for the information (history information 10) on the processing associated with the article 210 or inclusion input by the search request acquisition unit 204 and targeting the article 210 or inclusion or including the article 210 or inclusion as a target.

Next, the related information holding unit 102 stores index information 12, history management information 13, and the related information 14.

Here, the index information 12, the history management information 13, and the related information 14 will be described in detail.

### (Index Information)

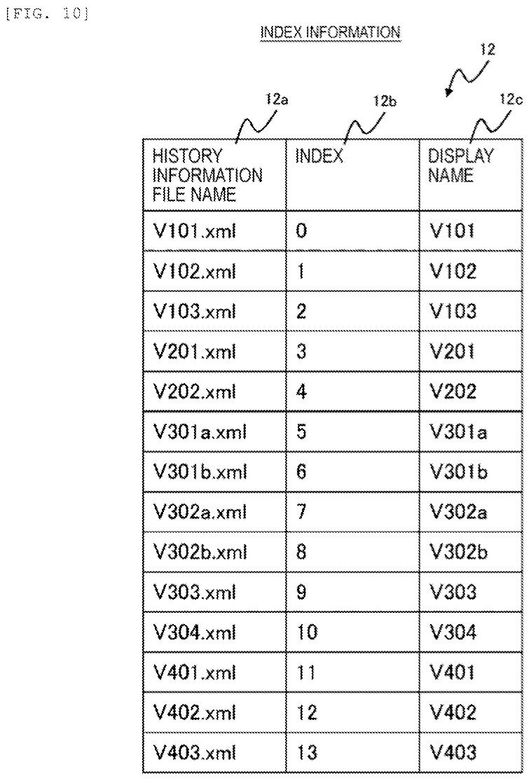

FIG. 10 is a diagram illustrating an example of the index information 12. The index information 12 is configured by at least one record having, as items, a history information file name 12a as a file name in which the history information 10 is registered, an index 12b as a number assigned with respect to the history information 10 related to the history information file name 12a, and a display name 12c as a name representing the history information 10 related to the history information file name 12a.

Next, a specific example of the history management information 13 will be described.

### (History Management Information)

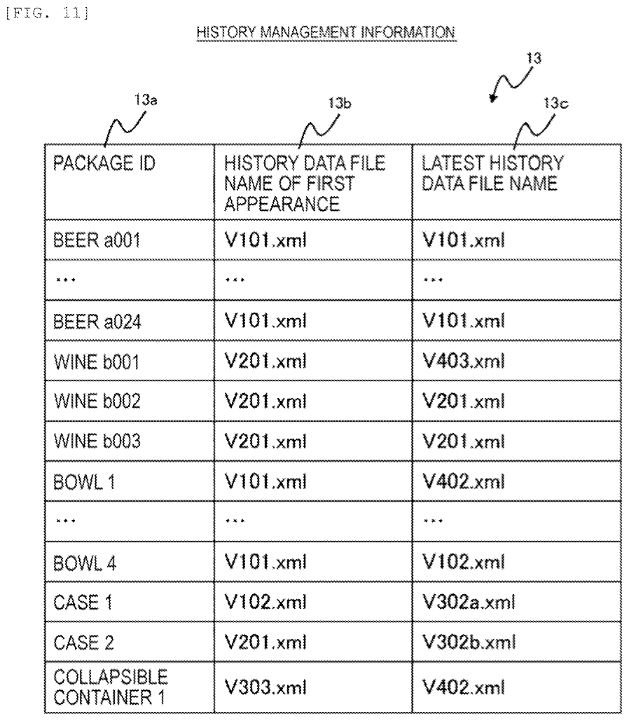

FIG. 11 is a diagram illustrating an example of the history management information 13. Stored in the history management information 13 is a correspondence relationship between each package and the history information 10 including information related to the processing of each package.

The history management information 13 is configured by at least one record having, as items, a package ID 13a specifying each package, an initial history file name 13b in which the file name of the history information 10 first received by the client terminal 200 among the history information 10 in which information on the package related to the package ID 13a is set (i.e. history information 10 of the most upstream process) is set, and a latest history file name 13c in which the file name of the history information 10 last received by the client terminal 200 among the history information 10 in which information on the package related to the package ID 13a is set (i.e. history information 10 of the most downstream process) is set.

It should be noted that the history management information 13 is used in, for example, creating or processing the related information 14, creating or updating the ownership information DB 11, and searching for a package.

Here, a specific example of the related information 14 will be described.

### (Related Information)

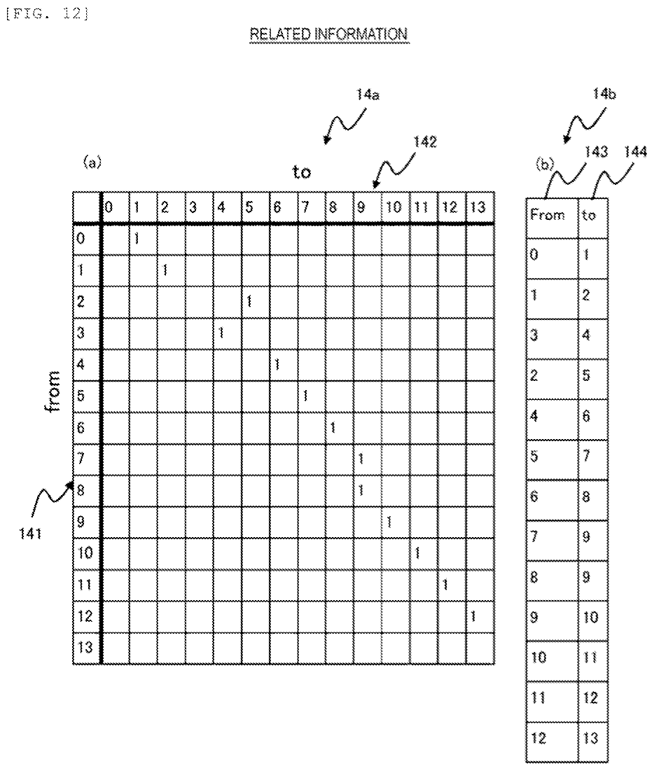

FIG. 12 is a diagram illustrating an example of the related information 14. The related information 14 indicates a relationship between the history information 10 and the history information 10 and is for searching for the history information 10 of the process of each package without omission. The related information 14 is information in which the history information 10 and the history information 10 that have a common processing target package are associated.

Related information 14a, which is an example of the related information 14, is represented by an adjacency matrix and includes rows 141 of the history information 10 (represented by index of history information 10) and columns 142 of the history information 10 (represented by index of history information 10). In a case where a value in a certain row 141 and a certain column 142 is “1”, the process in which the same package as the package processed in the process indicated by the history information 10 related to the row 141 is processed and that immediately follows the process indicated by the history information 10 related to the row 141 is the process indicated by the history information 10 related to the column 142.

Related information 14b, which is another example of the related information 14, is an edge list and includes a From item 143 in which the index of the history information 10 representing a certain process is set and a To item 144 in which the index of the history information 10 related to the process in which the same package as the package processed in the process related to the From item 143 is processed and that immediately follows the process indicated by the history information 10 related to the From item 143 is set.

In this manner, the related information 14 is information between the history information 10 and the history information 10 in which the process date and time is continuous for each process and information on the history information 10 in which the history information 10 and the history information 10 include information on the same processing target package.

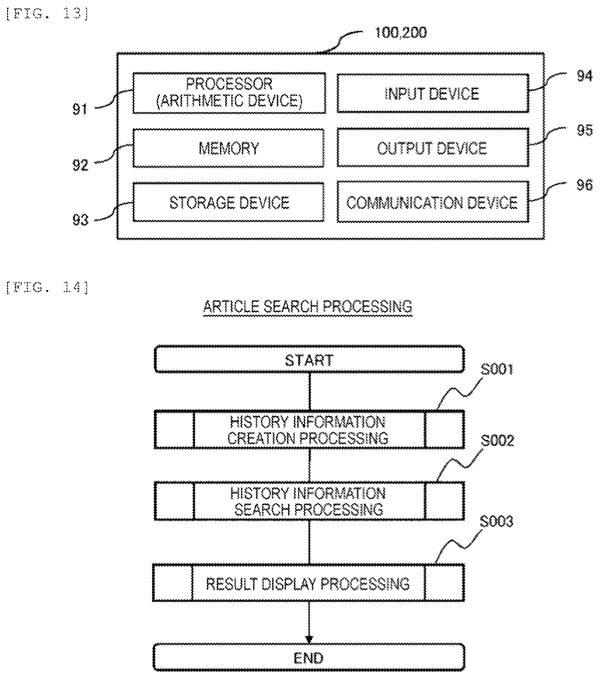

Next, FIG. 13 is a diagram illustrating an example of hardware of the search support device 100 and the client terminal 200. The search support device 100 and the client terminal 200 include a processor 91 (arithmetic device) such as a CPU, a memory 92 such as a random access memory (RAM) and a read-only memory (ROM) where software, data, and the like are loaded, a storage device 93 such as a hard disk drive (HDD), a solid state drive (SSD), and a flash memory, an input device 94 such as a keyboard and a touch panel, an output device 95 such as a monitor and a display, and a communication device 96 such as a network interface card communicating with another information processing device, which are interconnected by a bus or the like.

Each of the functions of the information processing devices in the article search support system 1 described above is implemented by dedicated hardware or by the processor 91 reading and executing a program stored in the memory 92 or the storage device 93. In addition, each program may be pre-recorded in a recording medium that can be read by each information processing device or may be introduced when necessary via a storage medium or a predetermined communication network.

### <Processing>

Next, an example of the processing that is performed in the article search support system 1 will be described. It should be noted that in the description of this specification, for the sake of convenience, one of the functional units (program modules) described above is the subject of the processing of each step.

### —Article Search Processing—

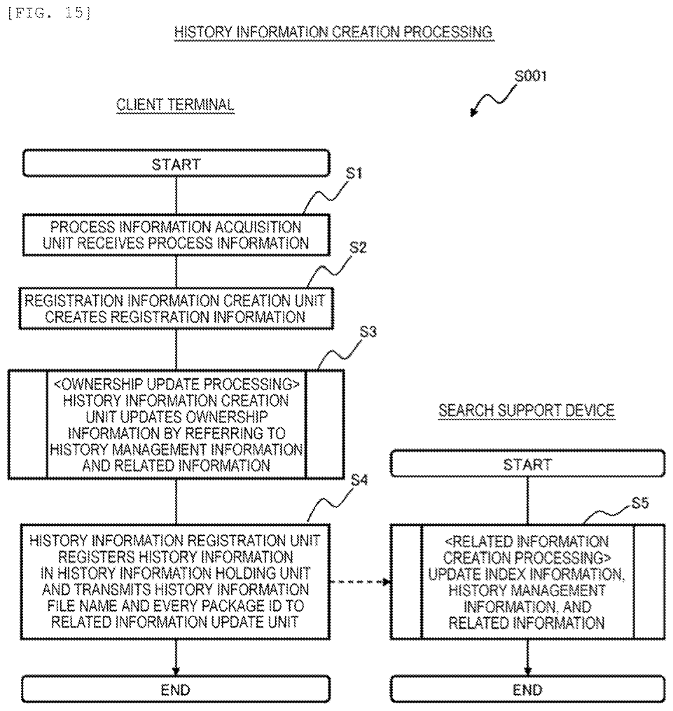

FIG. 14 is a flowchart illustrating a typical procedure of the article and package search-related processing (article search processing) performed in the article search support system 1. The article search processing is started when, for example, the search support device 100 is activated.

First, the article search support system 1 creates the history information 10 from the process information of each package and, based on the created history information 10, executes related information creation processing for creating the related information 14 indicating the relationship between the history information 10 and the history information 10 related to the packages (S001).

The article search support system 1 executes history information search processing for searching for the history information 10 corresponding to a search request based on an operator input to the client terminal 200 (S002). Then, the article search support system 1 executes result display processing for displaying the result of the history information search processing on the client terminal 200 of the search-requesting operator (S003).

Each processing in the article search processing will be described in detail below.

### —History Information Creation Processing—

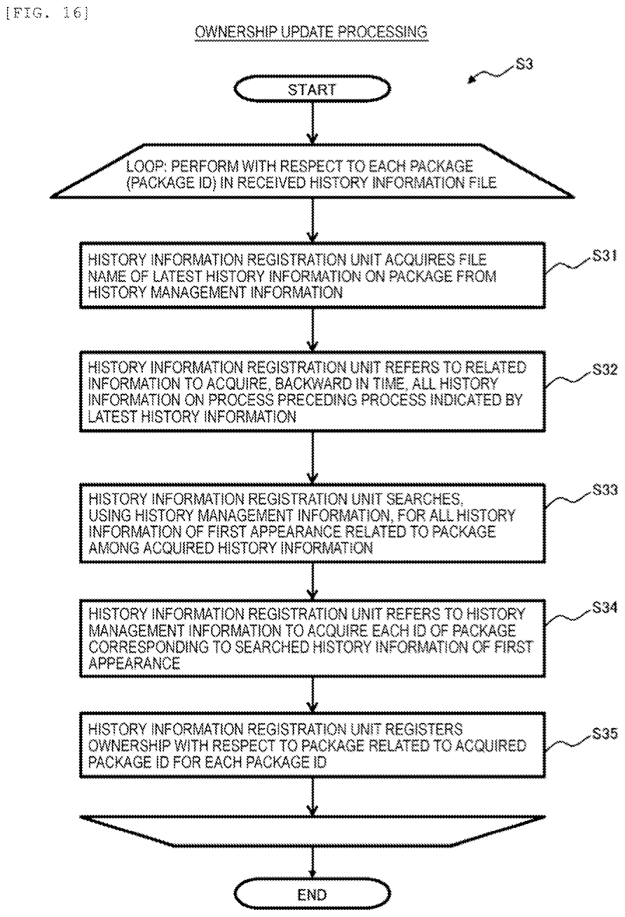

FIG. 15 is a flowchart illustrating an example of history information creation processing. The history information creation processing is started at, for example, a predetermined timing after the client terminal 200 is activated (e.g. predetermined time interval, predetermined time).

First, the process information acquisition unit 201 of the client terminal 200 receives the process information from the reading device 250 (S1).

The history information creation unit 202 creates the history information 10 based on the process information received in S1 (S2).

Specifically, for example, the history information creation unit 202 creates a blank history information 10 file and then analyzes the process information received in S1 to specify a correspondence relationship between the article 210 (beer, wine) and the first packing box 220 (bowl) in which the article 210 is packed, sets the ID of the article 210 as the child ID 1013 in the created file, and sets the ID of the first packing box 220 as the parent ID 1011 in the created file. The same applies to a correspondence relationship between the first packing box 220 and the second packing box 230 (case). In addition, the same applies to a correspondence relationship in the case of unpacking the first packing box 220 from the second packing box 230 and a correspondence relationship in the case of unpacking the article 210 from the first packing box 220.

It should be noted that the correspondence relationships may be pre-stored in the client terminal 200 or information specifying the correspondence relationships may be stored in a tag read by the reading device 250.

The history information creation unit 202 acquires the history management information 13 and the related information 14 from the search support device 100. Based on the acquired history management information 13 and related information 14 and the history information 10 created in S2, the history information creation unit 202 executes ownership update processing for updating the information on the ownership of the package (ownership information DB 11) registered in the history information 10 created in S2. The ownership update processing will be described in detail later.

Next, the history information creation unit 202 stores the history information 10 created in S2 in the history information DB 20 (S4). In addition, the history information creation unit 202 transmits the file name of the history information 10 created in S2 and the package ID of each package registered in the history information 10 created in S2 to the related information creation unit 101 of the search support device 100 (S4).

Meanwhile, the related information creation unit 101 of the search support device 100 executes the related information creation processing for creating the related information 14 together with the index information 12 and the history management information 13 based on the file name of the history information 10 and each package ID received from the client terminal 200 (S5). The related information creation processing will be described in detail later. The history information creation processing ends as a result of the above.

Each processing in the history information creation processing will be described in detail below.

### —Ownership Update Processing—

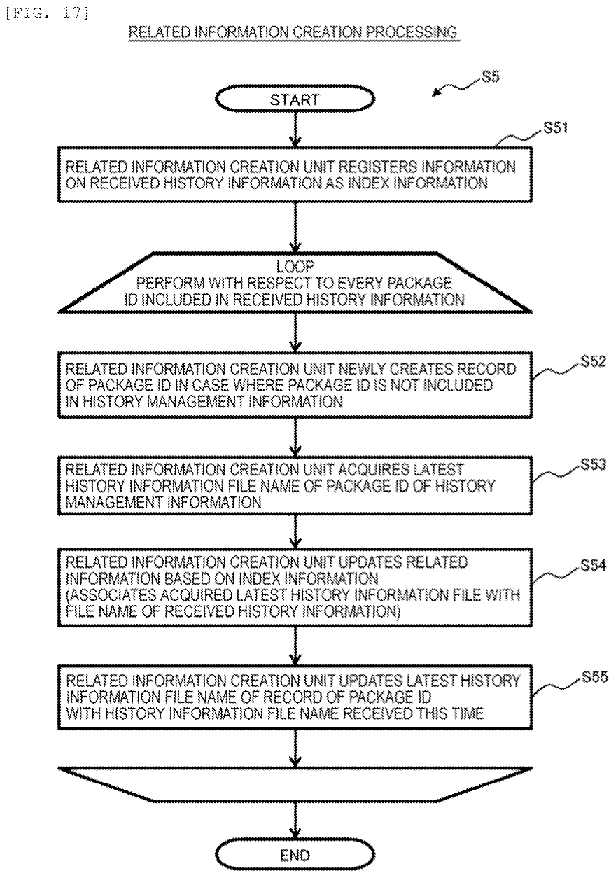

FIG. 16 is a flowchart illustrating the ownership update processing in detail.

First, the history information creation unit 202 selects one of all the packages indicated by the received history information 10 and searches for the latest history information 10 in which information on the selected package (hereinafter, referred to as selected package in this processing) is recorded (S31).

Specifically, for example, the history information creation unit 202 searches for the latest history file name 13c of the record of the history management information 13 in which the package ID of the selected package is set as the package ID 13a.

Next, the history information creation unit 202 searches, toward the upstream direction of the process, for all the history information 10 of the processes preceding the process indicated by the latest history information 10 searched for in S31 (S32).

For example, the history information creation unit 202 acquires the index of the latest history information 10 acquired in S31 from the index information 12, refers to the related information 14 to specify the index of every process preceding the process related to the acquired index while going back in time, and acquires the file name of the history information 10 corresponding to the specified index by referring to the index information 12.

Next, the history information creation unit 202 searches for the history information 10 in which information on the first processing with respect to the package is registered among the history information 10 searched for in S32 (S33).

Specifically, for example, the history information creation unit 202 acquires a record of the history management information 13 in which the file name of the history information 10 is set as the initial history file name 13b regarding the file name of each history information 10 searched for in S32.

Then, the history information creation unit 202 acquires information on the package corresponding to each history information 10 searched for in S33 (S34).

Specifically, for example, the history information creation unit 202 acquires the content of the package ID 13a of each record acquired in S33.

The history information creation unit 202 registers in the ownership information DB 11 that the ownership of the package ID acquired in S34 is held (S35).

Specifically, for example, the history information creation unit 202 associates information on the subject of the client terminal 200 related to the history information creation unit 202 (e.g. operator information, base information) with each package ID acquired in S34 and registers the associated information and package ID in the ownership information DB 11.

Then, the history information creation unit 202 repeats S31 and the subsequent processing in order to select another package as the selected package. After repeating this with regard to every package, the history information creation unit 202 ends the ownership update processing.

As described above, by searching for the history information 10 in which the history of information on the package as a concept including the article 210 and the packing box is registered backward in time, it is possible to specify the article 210 and set ownership with respect to the article 210 in a case where each package registered in the currently received history information 10 is at another base in the previous process, even in a case where the article 210 is packed in a packing box in the previous process and the content of the article 210 cannot be visually recognized in particular.

### —Related Information Creation Processing—

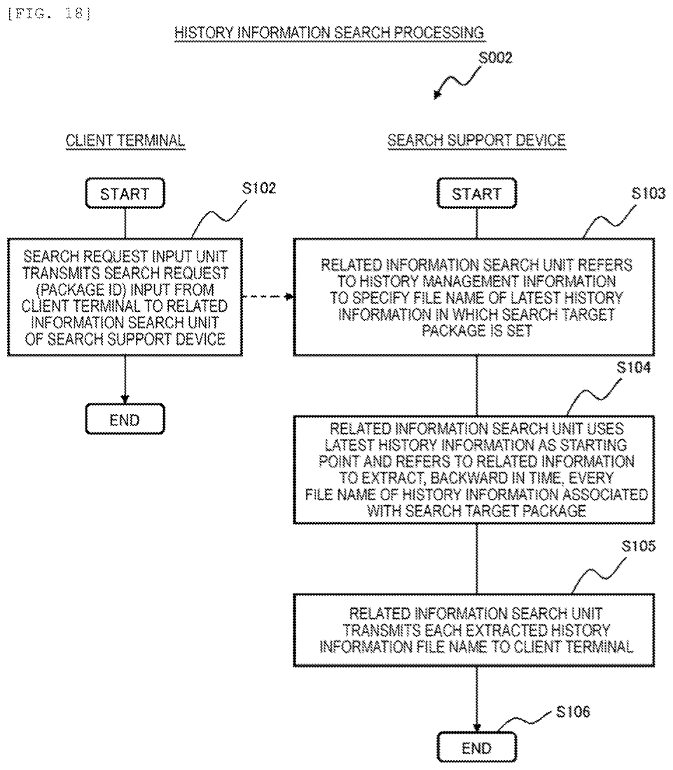

FIG. 17 is a flowchart illustrating the related information creation processing in detail.

First, the related information creation unit 101 registers the file name of the history information 10 received from the client terminal 200 in the index information 12 (s51).

Specifically, for example, the related information creation unit 101 registers the file name of the history information 10 received in S4 as the history information file name 12a of the index information 12, registers a number calculated in accordance with a predetermined rule (number unique to history information 10) as an index number 12b of the index information 12, and registers a character string determined in accordance with a predetermined rule (character string unique to history information 10) as the display name 12c. It should be noted that the character string registered as the display name 12c is, for example, obtained by removing extension from the file name of the history information 10.

Next, the related information creation unit 101 selects one of the package IDs received in S4 (hereinafter, referred to as selected package ID in this processing) and, in a case where no information on the package related to the selected package ID is registered in the history management information 13, creates a new record related to the selected package in the history management information 13 (s52).

Specifically, for example, the related information creation unit 101 sets the selected package ID as the package ID 13a of the history management information 13, the file name of the history information 10 received in S4 as the initial history file name 13b, and the file name of the history information 10 received in S4 as the latest history file name 13c.

Next, the related information creation unit 101 acquires the file name of the latest history information 10 related to the selected package ID from the history management information 13 (S53).

Specifically, for example, the related information creation unit 101 specifies the record of the history management information 13 in which the selected package ID is set as the package ID 13a and acquires the latest history file name 13c of the specified record.

The related information creation unit 101 updates the related information 14 based on the file name of the latest history information 10 acquired in S53 (S54).

Specifically, for example, the related information creation unit 101 creates a new record in the related information 14b and then sets the index of the file of the history information 10 received in s4 by referring to the index information 12 as the From item 143 of the record and sets the index of the file of the latest history information 10 acquired in S53 by referring to the index information 12 as the To item 144 of the record. As a result, the related information creation unit 101 associates the latest history information 10 with the history information 10 received in S4 this time.

Finally, the related information creation unit 101 updates the history management information 13 with the file name of the history information 10 received in S4 (S55).

Specifically, for example, the related information creation unit 101 specifies the record of the history management information 13 in which the selected package ID is registered as the package ID 13a and overwrites the latest history file name 13c of the specified record with the file name of the history information 10 received in S4.

Then, the related information creation unit 101 repeats S52 and the subsequent processing in order to select another package as the selected package. The related information creation unit 101 repeats this processing with regard to every package registered in the history information 10 received in S4.

### <History Information Search Processing>

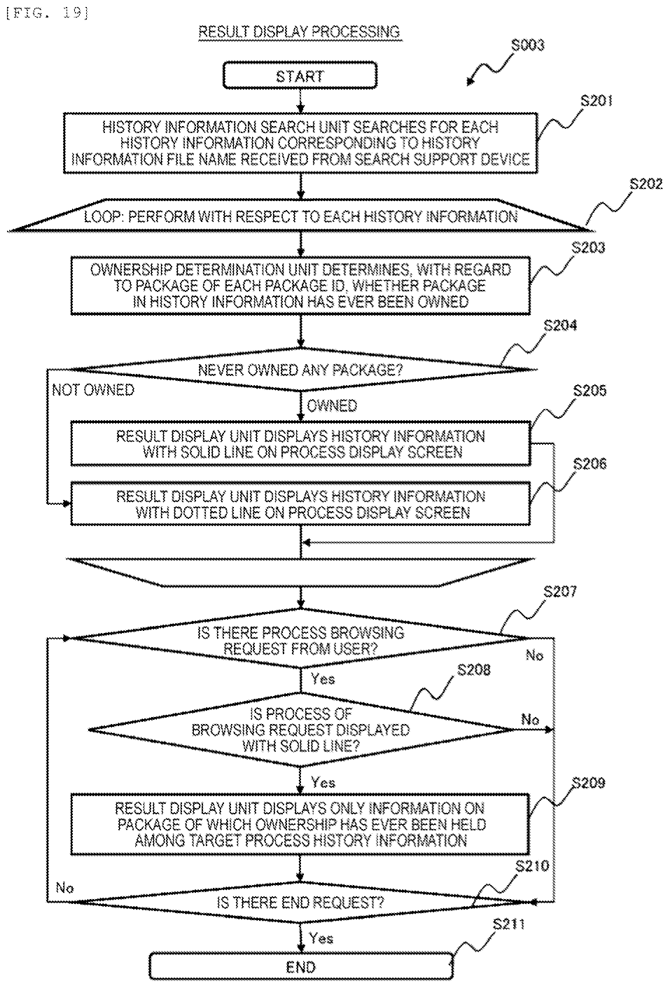

FIG. 18 is a flowchart illustrating an example of the history information search processing. The history information search processing is started, for example, in a case where a user of the client terminal 200 at a certain base (hereinafter, referred to as search base) performs a predetermined input.

First, the search request acquisition unit 204 of the client terminal 200 receives the input of a search request from a user by displaying a search screen (not illustrated) for receiving package-related search. The search request is, for example, the package ID of a history search package (article 210, first packing box 220, and second packing box 230).

It should be noted that the search request acquisition unit 204 may receive the search request input via the input device 94 or by reading a tag attached to each package (e.g. QR code (registered trademark), RFID tag) via the reading device 250.

Subsequently, the search request acquisition unit 204 transmits the input search request to the related information search unit 103 of the search support device 100 (S102). It should be noted that user information (e.g. subject-representing information such as information on base to which a user belongs, information on the client terminal 200 used by a user, and information on business operator to which a user belongs, hereinafter, referred to as subject information) is incidental to the search request.

The related information search unit 103 specifies the latest history information 10 among the history information 10 in which the package indicated by the search request (hereinafter, referred to as search target package) is registered (S103).

Specifically, for example, the related information search unit 103 specifies the file name of the history information 10 indicated by the latest history file name 13c of the record in the history management information 13 in which the package ID of the search target package is set as the package ID 13a.

The related information search unit 103 extracts all the history information 10 associated with the latest history information 10 specified in S103 while going back chronologically by referring to the related information 14 (S104).

Specifically, for example, the related information search unit 103 acquires, from the index information 13, each index corresponding to the file of each history information 10 extracted in S103. The related information search unit 103 acquires the index as the content of the From item 143 in the record in which the acquired index is set as the To item 144 among the records of the related information 14b and extracts the history information 10 related to the index as the chronologically previous history information 10. The related information search unit 103 repeats the above processing until no index can be acquired from the From item 143.

The related information search unit 103 transmits the file name of each history information 10 extracted in S104 (acquired from the index of the history information 10 and the history information file name 12a of the index information 12) to the result display unit 205 of the client terminal 200 at the search base (S105). The history information search processing ends as a result of the above (S106).

### <Result Display Processing>

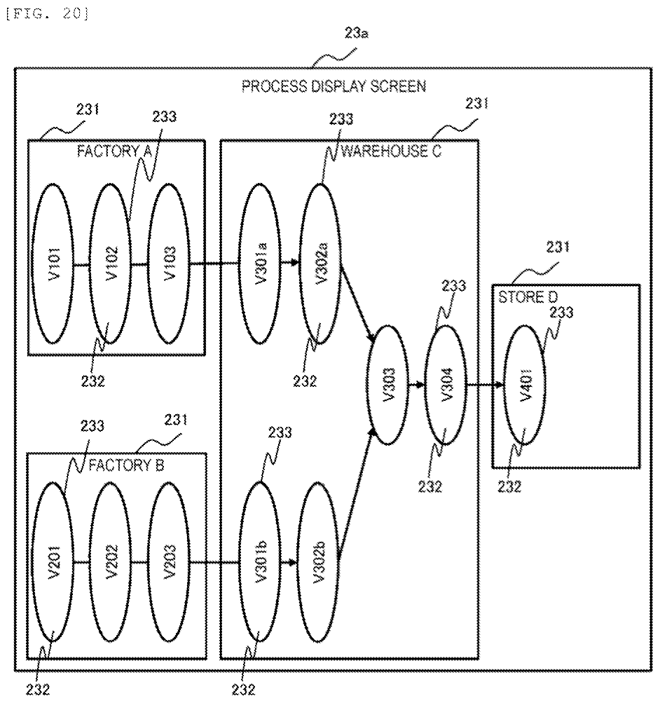

FIG. 19 is a flowchart illustrating an example of the result display processing. The result display unit 205 displays a process display screen 23 showing a process history related to each package.

First, the history information search unit 205b of the client terminal 200 at the search base receives the file name of each history information 10 based on the history information search processing of the search support device 100 and searches for the content of the history information 10 corresponding to the file name of each received history information 10 (S202).

It should be noted that in a case where the received history information 10 includes the history information 10 (process information) of the client terminal 200 at another base, the history information search unit 205b may transmit information requesting the acquisition of the history information 10 to the client terminal 200 at the other base and acquire the content of the history information 10 from the client terminal 200 at the other base (on condition that the content of the history information 10 can be acquired).

The ownership determination unit 205a selects one of the history information 10 searched for in S202 (hereinafter, referred to as selection process in this processing) and, based on the ownership information DB 11, specifies whether or not the subject related to the subject information holds the ownership of each package in the selection process (S203).

Specifically, for example, for each package in the selection process, the ownership determination unit 205a determines whether or not the ownership information DB 11 includes a record in which the package ID of the package is set as the package ID 11a and the subject information (e.g. search base information) is set as the owner lib.

It should be noted that in a case where the operator at the search base (subject information-related subject) also manages another base (e.g. case of convenience store operator managing warehouse C and store D), the ownership determination unit 205a determines that the operator is the owner of the package on condition that the operator is the owner of the package at any of the plurality of bases.

In a case where the subject information-related subject has no ownership holding history with regard to every package in the selection process (S204: not owned), the result display unit 205 performs the processing of S206, which will be described later. On the other hand, in a case where the subject information-related subject has an ownership holding history with regard to any package in the selection process (S204: owned), the result display unit 205 performs the processing of S205, which will be described later.

In S205, the result display unit 205 displays information on the selection process on the process display screen 23 and displays information indicating that the business operator at the search base (subject information-related subject) has had the ownership of any of the processing target packages of the selection process.

Specifically, for example, the result display unit 205 displays the information on the selection process with a solid line.

Then, the result display unit 205 repeats S203 and the subsequent processing in order to select another history information 10 as the selection process. The result display unit 205 repeats the above processing with regard to all the history information 10 received from the search support device 100. After the repetition with regard to all the history information 10, the result display unit 205 executes the processing of S207, which will be described later.

In S206, the result display unit 205 displays the information on the selection process on the process display screen 23 and displays information indicating that the business operator at the search base (subject information-related subject) has never had the ownership of any of the processing target packages of the selection process.

Specifically, for example, the result display unit 205 displays the information on the selection process with a dotted line.

Then, the result display unit 205 repeats S203 and the subsequent processing in order to select another package as the selection process. The result display unit 205 repeats the above processing with regard to every package registered in the history information 10 received from the search support device 100. After the repetition with regard to every package, the result display unit 205 executes the processing of S207, which will be described later.

Here, a specific example of the process display screen will be described.

### (Process Display Screen)

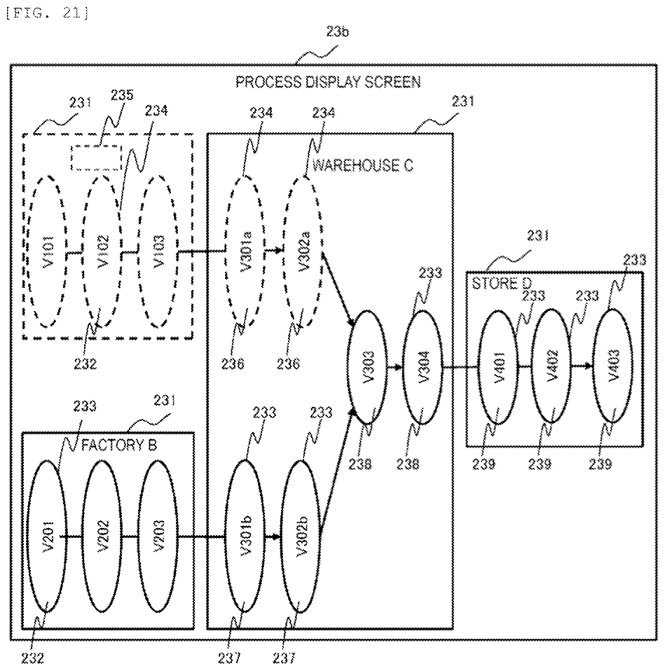

FIG. 20 is an example of the process display screen 23. A process display screen 23a is displayed by the client terminal 200 at the store D, which is the base of the seller. Further, the process display screen 23a is an example of a case where the seller managing the store D causes the client terminal 200 to execute the history information search processing with the collapsible container 1 as the search target package immediately before unpacking the collapsible container 1 received at the store D (i.e. immediately before the process V402).

As illustrated in FIG. 20, on the process display screen 23a, information on a base 231 where the package configuring the collapsible container 1 has been distributed and information on a process 232 performed at the base 231 are displayed with a solid line 233.

For example, the seller manages the store D and the warehouse C and every package (beer, wine, and packing box) at the factories A and B, which are upstream processes, is received at the warehouse C. Accordingly, the seller acquires the ownership of every package. As a result, the entire process 232 (process V101 to process V401) is displayed with the solid line 233 on the process display screen 23a.

FIG. 21 is a diagram illustrating another example of the process display screen 23. A process display screen 23b is displayed by the client terminal 200 of the manufacturer managing the factory B. Further, the process display screen 23b is an example of a case where the manufacturer managing the factory B causes the client terminal 200 to execute the history information search processing with the wine b001 as the search target package after the wine b001 is sold at the store D (i.e. after the process V403 is performed).

It should be noted that examples of such cases include a case where the manufacturer of the wine b001 wants to know the process of distribution of the wine because of a complaint from the purchaser of the wine b001 that the wine is strange in color or taste.

Here, the manufacturer managing the factory B has never held the ownership of the article 210 (beer) manufactured at the factory A.

Accordingly, the process display screen 23b does not display information on a process related to the article 210 of which ownership has never been acquired, specifically, information on a base 235 where this process is performed (factory A). On the other hand, the process display screen 23b displays, with the solid line 233, information on a process related to the article 210 of which ownership has been acquired, specifically, information on the base 231 where this process is performed (factory B, warehouse C, and store D).

In addition, the process display screen 23b displays, with a dotted line 234, information on the entire process 232 (process V101, process V102, and process V103) performed at the factory A and related to the beer a without being related to the wine. In addition, the process display screen 23b displays, with the dotted line 234, information on the entire process 236 (process V301a and process V302a) performed at the warehouse C and related only to the beer a without being related to the wine.

Meanwhile, the process display screen 23b displays, with the solid line 233, the entire process 237 (process V301b and process V302b) performed at the warehouse C and related to the wine b001 and the entire process 238 performed at the warehouse C and related to the wine b001 (beer a-related process may be included, process V303 and process V304). In addition, the process display screen 23b displays, with the solid line 233, the entire process 239 related to the wine b001 at the store D (beer a-related process may be included, process V401, process V402, and process V403).

With the above process display screen 23b, it is possible to present information on the wine b001 to the manufacturer of the wine b001 while keeping information on the beer manufacturer, which is another company, confidential. As a result, the purchasing strategy or the like of the beer manufacturer can be kept confidential from the wine manufacturer.

It should be noted that in a case where the process display screen 23 displays the history information 10 in large numbers, the displayed information may be reduced in amount. As a result, visibility is enhanced with respect to a search operator. For example, the history information 10 at the base may be displayed when only the information on each of the processes 231, 237, 238, and 239 is displayed on the process display screen 23 (e.g. figure display) and the search operator selects the part of display of the processes 231, 237, 238, and 239. In addition, for example, a priority order may be preset for each process and only the history information 10 of a high-priority process may be displayed on the process display screen 23 (e.g. receiving and shipping, packing, and unpacking are set as high-priority processes with other processes such as package movement at the same base set as low-priority processes).

Next, as illustrated in S207 in FIG. 19, the result display unit 205 confirms whether or not a browsing request is received from the client terminal 200 at the search base with respect to any of the processes 231, 237, 238, and 239 displayed on the process display screen 23.

In a case where the browsing request is received (S207: YES), the result display unit 205 executes the processing of S208, which will be described below. In a case where the browsing request is not received (S207: NO), the result display unit 205 executes the processing of S210, which will be described below.

In S208, the result display unit 205 determines whether or not the process for which the browsing request is received (hereinafter, referred to as browsing process) is the process displayed with the solid line 233 on the process display screen 23.

In a case where the browsing process is the process displayed with the solid line 233 (S208: YES), the result display unit 205 executes the processing of S209, which will be described below. In a case where the browsing process is not the process displayed with the solid line 233 (is the process displayed with the dotted line 234) (S208: YES), the result display unit 205 executes the processing of S210, which will be described later.

In S209, the result display unit 205 displays the content of the history information 10 of the browsing process on the process display screen 23.

At this time, the result display unit 205 may not display information on the package of which ownership has never been held by the operator at the search base among the information on the packages registered in the history information 10 or may display the information with the content of the package hidden (e.g. with the name of the article 210 replaced with the character string of “xxxx”).

In S210, the result display unit 205 determines whether or not a predetermined display end instruction is input from the client terminal 200 of the search operator.

In a case where the predetermined display end instruction is input (S210: YES), the result display unit 205 ends the result display processing (S211). In a case where the predetermined display end instruction is not input (S210: NO), the result display unit 205 repeats S207 and the subsequent processing.

### <Effects>

As described above, the article search support system 1 of the present embodiment associates the processing of the article 210 with the processing of the package containing the article 210 based on the information on the history of the processing of the plurality of articles 210 and the packing boxes of the plurality of articles 210 (history information 10 of packages) to create the related information 14 in which each processing of the article 210 and the package is chronologically stored. Meanwhile, the article search support system 1 of the present embodiment receives a package input from the user, searches for information on the package associated with the input package based on the related information 14, and outputs information on these processing.

As a result, by creating the related information 14 storing a relationship between the individual article 210 and packing box based on the history information 10 of each package, a user can confirm the content of the processing related to the package to be searched for even in a case where the package (article 210) to be searched for is contained in a packing box and the package cannot be directly confirmed.

In addition, according to the article search support system 1 of the present embodiment, it is possible to search for information on the processing of the article 210 with ease and in an appropriate range.

For example, each SC operator can search for the history information 10 of the article 210 in the packing box without unpacking the packing box by searching for the ID of the packing box (package ID) at the base of the operator. Although the package ID of the article 210 in the packing box exists only in the history information 10 of the manufacturer of the article 210, in a case where EPCIS data is used as the history information 10, for example, the operator usually needs to refer to the receiving record or inventory data on the article 210 registered in another system such as a warehouse management system (WMS) in order to grasp the content of the packing box. On the other hand, according to the article search support system 1 of the present embodiment, it is possible to search for the article 210 without such reference.

It should be noted that the present invention includes various modifications without being limited to the above example. The above example has been described in detail for better understanding of the present invention and is not necessarily limited to including every described configuration.

For example, the control and information lines illustrated in the present embodiment are those considered necessary for description, and not all control and information lines are necessarily shown on the product. In actuality, it may be considered that almost all configurations are interconnected.

In addition, although the search support device 100 is used by the manufacturer, the logistics provider, and the seller in the SC in the present embodiment, users are not limited thereto.

For example, a delivery operator delivering the article 210 between bases can be considered a service user. Further, users are not necessarily limited to those directly handling the process of article manufacturing or distribution. For example, in a case where a general consumer purchasing an article at a store refers to, for example, the temperature management history of the article 210, a smart phone held by the general consumer may be loaded with an application (native or web application) with functions similar to those of the client terminal 200 (e.g. search request acquisition unit 204 and result display unit 205) and the history of the article 210 may be searched for based on a search request transmitted from the smartphone.

In addition, although an operator has the ownership of the article 210 displayed with the solid line 233 on the process display screen 23 in the present embodiment, the operator may have another right. Examples of the non-ownership right include management authority. For example, in a case where a general consumer searches for the history of the article 210 before purchasing the article 210, the general consumer may be granted a right related to the article 210. Specifically, the search support device 100 may be provided with a function for setting a search right for a general consumer and ownership may be temporarily set during search by the general consumer.

In addition, as the article 210 handled by an operator increases in amount, the related information 14 and history management information 13 referred to may increase in information amount to result in an increase in load on the search support device 10. In such a case, the related information 14 and the history management information 13 may be dispersed by base or date and stored in the search support device 100. In addition, the related information 14 may be dispersed and stored in a plurality of information processing devices (e.g. information processing devices respectively provided at bases). As a result, the processing load of the search support device 100 can be reduced.

In addition, although the example of the article 210 at a warehouse and the packing box packed with the article 210 has been described as an example of the article 210 and an inclusion containing the article 210 in the present embodiment, the article may be of another type. For example, it can also be applied to manufacturing process history management at a product manufacturing site (e.g. cases of manufacturing a product by assembling a plurality of components and manufacturing a plurality of products from the same component or material).

In addition, how to create the related information 14 is not limited to that described in the present embodiment and may be based on any other algorithm. In other words, the search support device 100 may specify a relationship between the article 210 and the article 210-packing package, that is, a relationship in which one includes the other with regard to each article 210 and each package and information chronologically specifying the processing targeting each article 210 and each package may be created as the related information 14 under the premise that the processing targeting the package (article 210 packing and unpacking) is with respect to the article 210 as well as the package.

In addition, the article search support system 1 of the present embodiment is also applicable to a wider range of logistics such as trade and international logistics.

In addition, the article search support system 1 of the present embodiment can be implemented using a blockchain system. For example, as for the history information 10 and the related information 14, it is possible to enhance the tamper resistance of the history information 10 and the fault resistance of a database (DB) by using a blockchain (BC) that can be stored in the DB in the BC. It should be noted that examples of how to save the history information 10 in the BC include saving only a root hash summarizing the hash values of a plurality of pieces of the history information 10 in the DB of a key-value-type BC. In this case, for example, the key is a value obtained by combining the file name of the history information 10 with a predetermined character string (e.g. V101_V102_V103) and the root hash is set for each article 210 subject to packing and unpacking. Likewise, the related information 14 can also be represented by a DB key of the BC.

In addition, although each client terminal 200 stores the substance of the history information 10 in the present embodiment, the substance of the history information 10 may be stored by the search support device 100. In this case, each operator may be able to refer to the content of the history information 10 related to another operator's package, and thus access restrictions may be provided so that browsing from another operator is restricted with respect to each history information 10.

In addition, in a case where a certain operator conducts search, another operator's article 210 packed together with the operator's article 210 may be searchable. For example, in some cases, in order for a certain maker to carry out a recall in response to a complaint that a fabric product, such as clothing, manufactured by the maker and sold at a home center is odorous, the maker wants to check whether an article with a strong smell, such as food and pet food, manufactured by another operator is mixed in the process of distribution of the article 210 of the maker. In such a case where, for example, a packing box search request is received from the client terminal 200 of the manufacturer, the search support device 100 may transmit, to the client terminal 200 that has transmitted process information related to another operator's article 210 contained in the packing box, inquiry information on whether or not the disclosure of information on the other operator's article 210 is permitted. In a case where an information disclosure permission reply is received, the search support device 100 displays the content of the history information 10 related to the other operator's article 210 on the process display screen 23. As a result, it is possible to quickly specify the cause in the event of recall execution or complaint response.

In addition, additional information related to each package (e.g. temperature history) may be registered in the history information 10. As a result, a search operator can guess why the article 210 is defective by referring to the additional information during search in a case where, for example, the article 210 manufactured by the search operator being defective (e.g. wine changes in color or taste) is detected by the search operator.

In addition, although the history information 10 is based on EPCIS and thus the packing processing is performed in two layers (first packing box 220 and second packing box 230) in the present embodiment, packing processing in three or more layers may be performed by using another data format.

In addition, although the search support device 100 uses a file name as information for specifying the history information 10 of each client terminal 200 in the present embodiment, any other identifier may be used.

In addition, although the solid line 233 and the dotted line 234 are adopted as methods for display on the process display screen 23 in the present embodiment, any other display method may be adopted insofar as it is possible to distinguish between the presence and absence of ownership.

At least the following is clarified from the above description of this specification. In other words, in the article search support system 1 of the present embodiment, the arithmetic device may update the related information by associating the processing of the article and inclusion created in the history information creation processing with latest processing of the article or inclusion in the related information that is already created in the related information creation processing.

In this manner, by associating the created history information 10 with the information on the latest processing of the package in the already created related information 14, the record of the history of the processing of each package is accumulated in the related information 14. Based on the related information 14, a user can search for the package even in a case where the package is distributed through multiple processes.

In addition, in article search support system 1, the arithmetic device may store information on a right holder having authority over each of the processing in the history information creation processing.

Search can be facilitated by storing the information on the right holder of each package indicated by the history information 10 in this manner.

In addition, in the article search support system 1, the arithmetic device may determine whether or not a subject has ever had authority over the searched article or inclusion based on information on the subject incidental to information on the input article or inclusion and the stored right holder information and vary how to display information on processing targeting the searched article or inclusion depending on whether or not the subject has ever had authority over the searched article or inclusion in the search result display processing.

In this manner, by varying how to display the information on the processing of the article 210 or inclusion depending on whether or not the user searching for the article 210 or inclusion has ever had authority over the article 210 or inclusion, it is possible to provide the user with only appropriate range of information.

As a result, for example, even in a case where the articles 210 from a plurality of makers (stakeholders) are mixed in a package, it is possible not to present information on the article 210 that another user is entitled to in order to keep the information confidential from the user that searched for the article 210.

In addition, the article search support system 1 may be configured to include a plurality of client terminals provided with an arithmetic device executing the history information creation processing, the search request acquisition processing, and the search result display processing and a search support device provided with an arithmetic device executing the related information creation processing, the client terminal may transmit an identifier of the information on the history of each processing created in the history information creation processing to the search support device, and the search support device may create the related information by associating the processing of the article with the processing of the inclusion containing the article based on each of the received identifiers in the related information creation processing.

In this manner, by each client terminal 200 transmitting the history information 10 to the search support device 100 and the search support device 100 creating the related information 14 based on the identifier, the search support device 100 is capable of creating the related information 14 even without acquiring the content of the history information 10 from each client terminal 200. In other words, an operator handling each package can retain the substance of the history information 10 related to the package of the operator as it is and does not need to provide the substance to the search support device 100. As a result, the confidentiality of the information on each operator's package at each base can be maintained, and it is possible to suppress the bloating of management target information with respect to the search support device 100 as well.

Further, in the article search support method in the present embodiment, an information processing device may execute: history information creation processing for creating information on a history of processing of a plurality of articles and a history of processing of an inclusion containing at least one of the plurality of articles entailing the processing of the at least one article; related information creation processing for creating related information as information chronologically storing each processing targeting the article and the inclusion by associating the processing of the article with the processing of the inclusion containing the article based on the created information on the history of each processing; search request acquisition processing for receiving an article or inclusion input from a user; related information search processing for searching the created related information for information on processing associated with the input article or inclusion and targeting the article or the inclusion; and search result display processing for outputting the searched processing information.

In addition, in the article search support method, the information processing device may update the related information by associating the article and inclusion processing created in the history information creation processing with latest article or inclusion processing in the related information already created in the related information creation processing.

In addition, in the article search support method, the information processing device may store information on a right holder having authority over each of the processing in the history information creation processing.

In addition, in the article search support method, the information processing device may determine whether or not a subject has ever had authority over the searched article or inclusion based on information on the subject incidental to information on the input article or inclusion and the stored right holder information and vary how to display information on processing targeting the searched article or inclusion depending on whether or not the subject has ever had authority over the searched article or inclusion in the search result display processing.

In addition, in the article search support method, the information processing device may be configured to include a plurality of client terminals provided with an arithmetic device executing the history information creation processing, the search request acquisition processing, and the search result display processing and a search support device provided with an arithmetic device executing the related information creation processing, the client terminal may transmit an identifier of the information on the history of each processing created in the history information creation processing to the search support device, and the search support device may create the related information by associating the processing of the article with the processing of the inclusion containing the article based on each of the received identifiers in the related information creation processing.

### REFERENCE SIGNS LIST

1: article search support system
100: search support device
200: client terminal
210: article
14: related information

1. An article search support system comprising an arithmetic device configured to execute:
history information creation processing for creating information on a history of processing of a plurality of articles and a history of processing of an inclusion containing at least one of the plurality of articles entailing the processing of the at least one article;
related information creation processing for creating related information as information chronologically storing processing targeting the article and the inclusion or including the article and the inclusion as targets by associating the processing of the article with the processing of the inclusion containing the article based on the created information on the history of each processing;
search request acquisition processing for receiving an article or inclusion input from a user;
related information search processing for searching the created related information for information on processing associated with the input article or inclusion and targeting the article or the inclusion or including the article or the inclusion as a target; and
search result display processing for outputting the searched processing information.

2. The article search support system according to claim 1, wherein the arithmetic device is configured to update the related information by associating the article and inclusion processing created in the history information creation processing with latest article or inclusion processing in the related information already created in the related information creation processing.

3. The article search support system according to claim 1, wherein the arithmetic device is configured to store information on a right holder having authority over each of the processing in the history information creation processing.

4. The article search support system according to claim 3, wherein the arithmetic device is configured to determine whether or not a subject has ever had authority over the searched article or inclusion based on information on the subject incidental to information on the input article or inclusion and the stored right holder information and vary how to display information on processing targeting the searched article or inclusion depending on whether or not the subject has ever had authority over the searched article or inclusion in the search result display processing.

5. The article search support system according to claim 1, comprising:
a plurality of client terminals provided with an arithmetic device configured to execute the history information creation processing, the search request acquisition processing, and the search result display processing; and
a search support device provided with an arithmetic device configured to execute the related information creation processing, wherein
the client terminal transmits an identifier of the information on the history of each processing created in the history information creation processing to the search support device, and
the search support device creates the related information by associating the processing of the article with the processing of the inclusion containing the article based on each of the received identifiers in the related information creation processing.

6. An article search support method in which an information processing device executes:
history information creation processing for creating information on a history of processing of a plurality of articles and a history of processing of an inclusion containing at least one of the plurality of articles entailing the processing of the at least one article;
related information creation processing for creating related information as information chronologically storing processing targeting the article and the inclusion or including the article and the inclusion as targets by associating the processing of the article with the processing of the inclusion containing the article based on the created information on the history of each processing;
search request acquisition processing for receiving an article or inclusion input from a user;
related information search processing for searching the created related information for information on processing associated with the input article or inclusion and targeting the article or the inclusion or including the article or the inclusion as a target; and
search result display processing for outputting the searched processing information.

7. The article search support method according to claim 6, wherein the information processing device updates the related information by associating the article and inclusion processing created in the history information creation processing with latest article or inclusion processing in the related information already created in the related information creation processing.

8. The article search support method according to claim 6, wherein the information processing device stores information on a right holder having authority over each of the processing in the history information creation processing.

9. The article search support method according to claim 8, wherein the information processing device determines whether or not a subject has ever had authority over the searched article or inclusion based on information on the subject incidental to information on the input article or inclusion and the stored right holder information and varies how to display information on processing targeting the searched article or inclusion depending on whether or not the subject has ever had authority over the searched article or inclusion in the search result display processing.

10. The article search support method according to claim 6, wherein
the information processing device is configured to include a plurality of client terminals provided with an arithmetic device executing the history information creation processing, the search request acquisition processing, and the search result display processing and a search support device provided with an arithmetic device executing the related information creation processing,
the client terminal transmits an identifier of the information on the history of each processing created in the history information creation processing to the search support device, and
the search support device creates the related information by associating the processing of the article with the processing of the inclusion containing the article based on each of the received identifiers in the related information creation processing.
